(19) United States
(12) Patent Application Publication
(10) Pub. No.: US 2015/0240680 A1
(43) Pub. Date: Aug. 27, 2015

(54) CLEANING TOOL FOR DIESEL PARTICULATE FILTER

(71) Applicant: Caterpillar Inc., Peoria, IL (US)

(72) Inventor: Steven F. Meister, Chillicothe, IL (US)

(73) Assignee: Caterpillar Inc., Peoria, IL (US)

(21) Appl. No.: 14/708,390

(22) Filed: May 11, 2015

(51) Int. Cl. F01N 3/023; B01D 46/00

(52) U.S. Cl. CPC F01N 3/0232; B01D 46/0079

(57) ABSTRACT

A cleaning tool for a diesel particulate filter is provided. The cleaning tool includes a support assembly and a cleaning assembly. The support assembly includes a base block, a locator block, and a support block. The support assembly further includes a pair of support rods fixedly connected to the locator block and slidably connected to the base block and the support block. An action of an external force on the base block causes a contemporaneous sliding motion of the pair of support rods. The cleaning assembly includes a plurality of pins connected to and passing through the base block, the support block, and the locator block. Each of the plurality of pins is configured to contemporaneously enter into each of the plurality of passages and penetrate an ash column deposited at one end of the respective passage and dislodge the ash column therefrom.

### TECHNICAL FIELD

The present disclosure relates generally to a tool for cleaning, and more particularly to the tool for cleaning of a diesel particulate filter.

### BACKGROUND

Filter elements associated with engine systems may get blocked by contaminants or particulate matter separated from an airflow of the engine system, thereby requiring periodic cleaning and servicing of the filter element. During regeneration of the filter element, particulate matter such as ash, that does not burn during the regeneration process, may collect and deposit within the filter.

The deposited ash may be removed using pneumatic cleaning However, sometimes a hard crust may be formed on the ash collected within the filter element leading to formation of ash columns within the filter element. In such cases, the pneumatic cleaning process may not be effective to blow out the ash from the filter element.

U.S. Published Application 2008/0006155, hereinafter referred to as the '155 application, relates to a method for cleaning a diesel particulate filter through a particulate filter cleaning device. The cleaning is achieved by loosening and removing ash stuck to inner walls of filter passages in the diesel particulate filter. However, '155 application does not describe a tool for cleaning of the ash columns in the diesel particulate filter.

### SUMMARY OF THE DISCLOSURE

In one aspect of the present disclosure, a cleaning tool for a diesel particulate filter is provided. The cleaning tool includes a support assembly. The support assembly includes a base block provided at one end of the cleaning tool. The cleaning tool also includes a locator block provided at another end of the cleaning tool. The locator block includes a plurality of indexing pins configured to align and position the cleaning tool on an inlet face of the diesel particulate filter. The support assembly further includes a support block provided between the base block and the locator block. The support assembly further includes a pair of support rods laterally spaced apart with respect to a central axis of the cleaning tool. Each of the pair of support rods is fixedly connected to the locator block and slidably connected to the base block and the support block. An action of an external force on the base block causes a contemporaneous sliding motion of the pair of support rods. The cleaning tool further includes a cleaning assembly. The cleaning assembly includes a plurality of pins connected to and passing through the base block, the support block, and the locator block. The plurality of pins is positioned between the pair of support rods. A diameter of each of the plurality of pins is smaller than a diameter of each of the plurality of passages of the diesel particulate filter. Each of the plurality of pins is configured to contemporaneously enter into each of the plurality of passages based on the action of the external force. Each of the plurality of pins is configured to penetrate an ash column deposited at one end of the respective passage and dislodge the ash column therefrom.

Other features and aspects of this disclosure will be apparent from the following description and the accompanying drawings.

### BRIEF DESCRIPTION OF THE DRAWINGS

FIG. 1 is a schematic view of an exemplary service system connected to a diesel particulate filter, according to one embodiment of the present disclosure;

FIG. 2 is a perspective view of a cleaning tool, according to one embodiment of the present disclosure;

FIG. 3 is another perspective view of the cleaning tool during operation, according to one embodiment of the present disclosure;

FIG. 4 is schematic view of a front view of the cleaning tool and a sectional view of the diesel particulate filter, showing the cleaning tool mounted onto and partially inserted into the diesel particulate filter, according to one embodiment of the present disclosure; and

FIG. 5 is schematic view of a front view of the cleaning tool and a sectional view of the diesel particulate filter, showing the cleaning tool mounted onto and completely inserted into the diesel particulate filter, according to one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

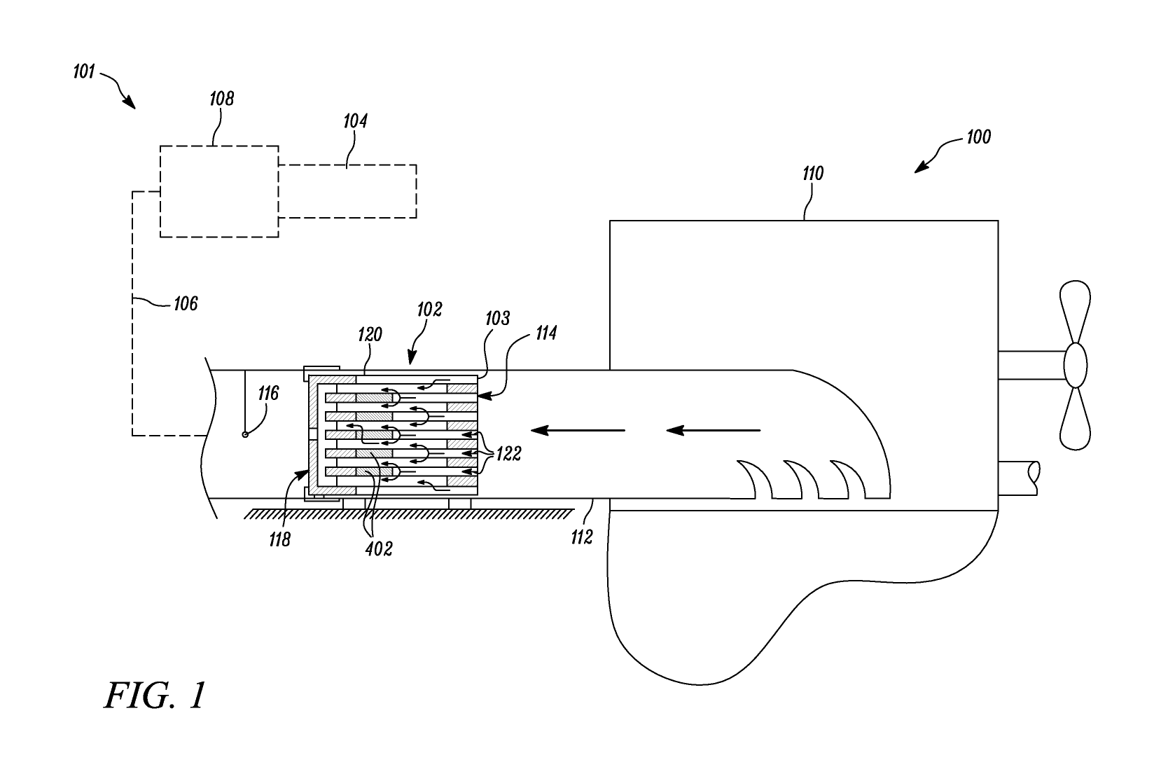

Referring to FIG. 1, an exemplary diesel particulate filter service system 100 connected to a diesel particulate filter (DPF) 102. The diesel particulate filter 102 in the accompanying figures is exaggerated in size for illustrative purposes to clearly show an internal structure of the diesel particulate filter 102 with reference to subsequent explanation in the later parts of this section. In reality, the diesel particulate filter 102 may be much smaller in size, such that the diesel particulate filter 102 may be easily accommodated within an exhaust line 112.

The diesel particulate filter service system 100 includes an ash removal system 101. The ash removal system 101 includes one or more receptacles 104, a matter removal line 106, and a vacuum source 108. Components of the ash removal system 101 may be operatively attached to the diesel particulate filter 102 for service and may be disconnected from the diesel particulate filter 102 when the service is complete. A user may operatively attach and remove components of the ash removal system 101 and may service the diesel particulate filter 102 without removing the diesel particulate filter 102 from an associated environment thereof, for example, a machine, a vehicle, or other devices to which the diesel particulate filter 102 is attached. As used herein, the term “machine” may include on-road vehicles, off-road vehicles, and stationary machines, such as, for example, generators and other exhaust-producing devices.

Referring to FIG. 1, the diesel particulate filter 102 is connected to an internal combustion engine 110, such as, for example, a diesel engine. An inlet face 103 of the diesel particulate filter 102 is exposed to the internal combustion engine 110. The engine 110 may include an exhaust line 112 connecting the engine 110 with an inlet end 114 of the diesel particulate filter 102. In one embodiment, the engine 110 may include a turbo (not shown) connected to the exhaust line 112. In this case, the inlet end 114 of the diesel particulate filter 102 may be connected to an outlet of the turbo.

One or more machine diagnostic devices 116 may be disposed proximate an outlet end 118 of the diesel particulate filter 102. The machine diagnostic devices 116 may be, for example, part of the work machine or other device to which the diesel particulate filter 102 is connected and may be external to the diesel particulate filter 102. Alternatively, the machine diagnostic devices 116 may be internal to the diesel particulate filter 102. The machine diagnostic devices 116 may be any sensing devices known in the art, such as, for example, flow meters, emission meters, pressure transducers, radio devices, or other sensors. Such machine diagnostic devices 116 may sense, for example, an increase in the levels of soot, NOx, or other pollutants leaving the diesel particulate filter 102. The machine diagnostic devices 116 may send contaminant-level information to a controller or other device (not shown) and may assist in, for example, triggering diesel particulate filter regeneration and diesel particulate filter servicing indicator.

The diesel particulate filter 102 may be any type of particulate filter, such as, for example, a foam cordierite, sintered metal, or silicon carbide type filter. As illustrated in FIG. 1, the diesel particulate filter 102 includes filter media 120. The filter media 120 may include any material useful in removing contaminants from an exhaust flow of the engine 110. The filter media 120 contains catalyst materials capable of collecting, for example, soot, NOx, sulfur compounds, particulate matter, and other contaminants known in the art. Such catalyst materials may include, for example, alumina, platinum, rhodium, barium, cerium, and alkali metals, alkaline-earth metals, rare-earth metals, or combinations thereof.

For the purposes described herein, the filter media 120 defines a plurality of passages 122. The passages 122 are arranged parallel to a central axis of the exhaust line 112. The passages 122 may have desired porosities and other characteristics based on the catalyst materials of the filter media 120, and may be configured to allow exhaust gases diffuse through the given passage 122 of the diesel particulate filter 102 into adjacent passages 122. The contaminants or the particulate matter present in the exhaust gases may be retained in the given passage 122, while the filtered exhaust gases may be allowed to enter into the adjacent passages 122. Arrows shown in the accompanying figure is indicative of a direction of flow of the exhaust gases. The system 100 may additionally include other components not shown herein. The system 100 described above is on an exemplary basis and does not limit the scope of the present disclosure. Additionally, the location of the diesel particulate filter 102 may vary and is not limited to that depicted in the accompanying drawings.

During operation of the engine 110, the contaminants or particulate matter present in the exhaust gases that is separated therefrom may collect in the passages 122 of the diesel particulate filter 102. Particulate matter such as ash may deposit within the diesel particulate filter 102. In one example, ash columns 402 are formed within the passages 122 of the diesel particulate filter 102; such that the ash collected within the passages 122 of the diesel particulate filter 102 may have a hard crust formed thereon.

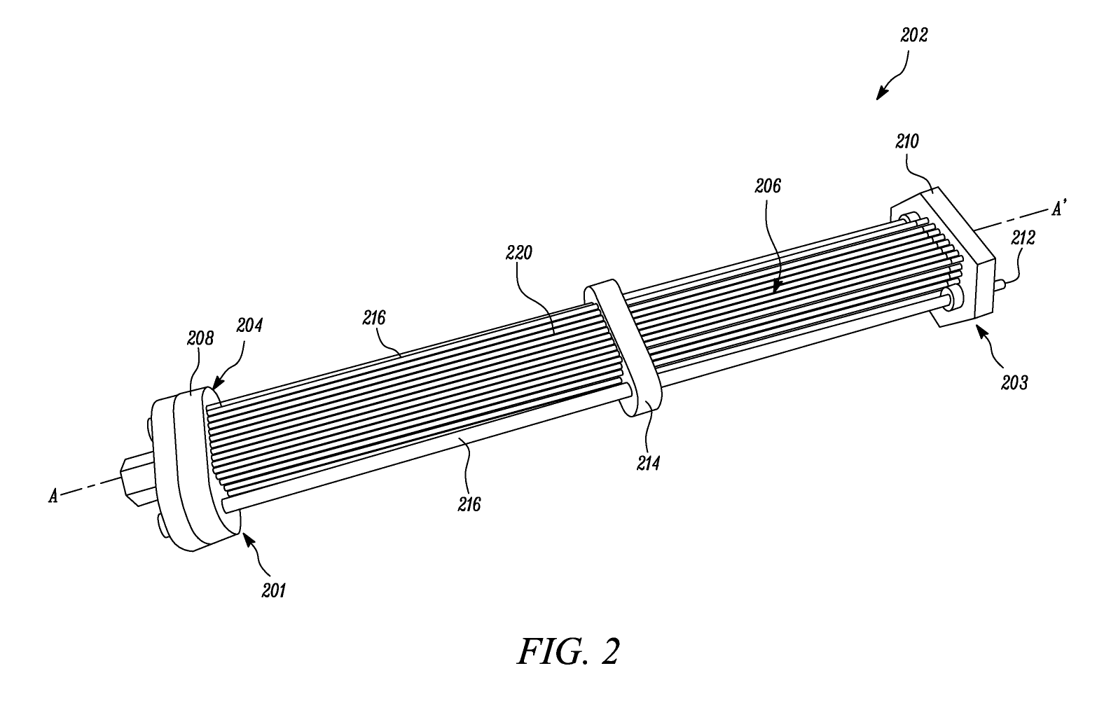

The present disclosure relates to a cleaning tool 202 (see FIG. 2) for penetrating and dislodging the ash columns 402 that are deposited within the passages 122 of the diesel particulate filter 102. The structure and working of the cleaning tool 202 will explained in detail in connection with FIGS. 2 to 5. After dislodging of the ash columns 402 from the passages 122 of the diesel particulate filter 102, the vacuum source 108 is connected to the diesel particulate filter 102 to blow out the dislodged ash particles therefrom.

Referring to FIG. 2, the cleaning tool 202 includes a support assembly 204 and a cleaning assembly 206 coupled to the support assembly 204. The support assembly 204 includes a base block 208 provided at one end 201 of the cleaning tool 202. The support assembly 204 further includes a locator block 210 provided at another end 203 of the cleaning tool 202. The locator block 210 includes one or more indexing pins 212 for securing the cleaning tool 202 to the inlet face 103 of the diesel particulate filter 102 during cleaning

The support assembly 204 further includes a support block 214 provided between the base block 208 and the locator block 210. The support block 214 provides mechanical strength and support to different components of the cleaning tool 202 and prevents collapse of the cleaning tool 202 during operation. The base block 208, the locator block 210, and the support block 214 are made up of PLEXIGLAS material. Alternatively, the base block 208, the locator block 210, and the support block 214 may be made of any metallic or non-metallic material.

The support assembly 204 also includes a pair of support rods 216. The support rods 216 are spaced laterally apart with respect to a central axis A-A′ of the cleaning tool 202. Each of the support rods 216 are fixedly connected to the locator block 210. Further, the support rods 216 are slidably connected to the base block 208 and the support block 214. The support rods 216 are cylindrical rods received into corresponding openings provided on the base block 208, the locator block 210, and the support block 214. The cleaning assembly 206 of the cleaning tool 202 includes a number of pins 220. The pins 220 are fixedly connected to the base block 208. The pins 220 pass through corresponding openings in the support block 214 and the locator block 210. The pins 220 are embodied as elongate carbon fiber pins. Alternatively, the pins 220 may be made of any metallic or non-metallic material.

A diameter of the pins 220 is lesser than the diameter of the passages 122 of the diesel particulate filter 102, so that the pins 220 can easily slide into the passages 122 during operation of the cleaning tool 202. Further, the arrangement of the pins 220 between the support rods 216 is in such a manner, that a pattern in which the pins 220 are provided on the cleaning tool 202 corresponds to that of the diesel particulate filter 102. A length of the pins 220 may also vary based on dimensions of the diesel particulate filter 102.

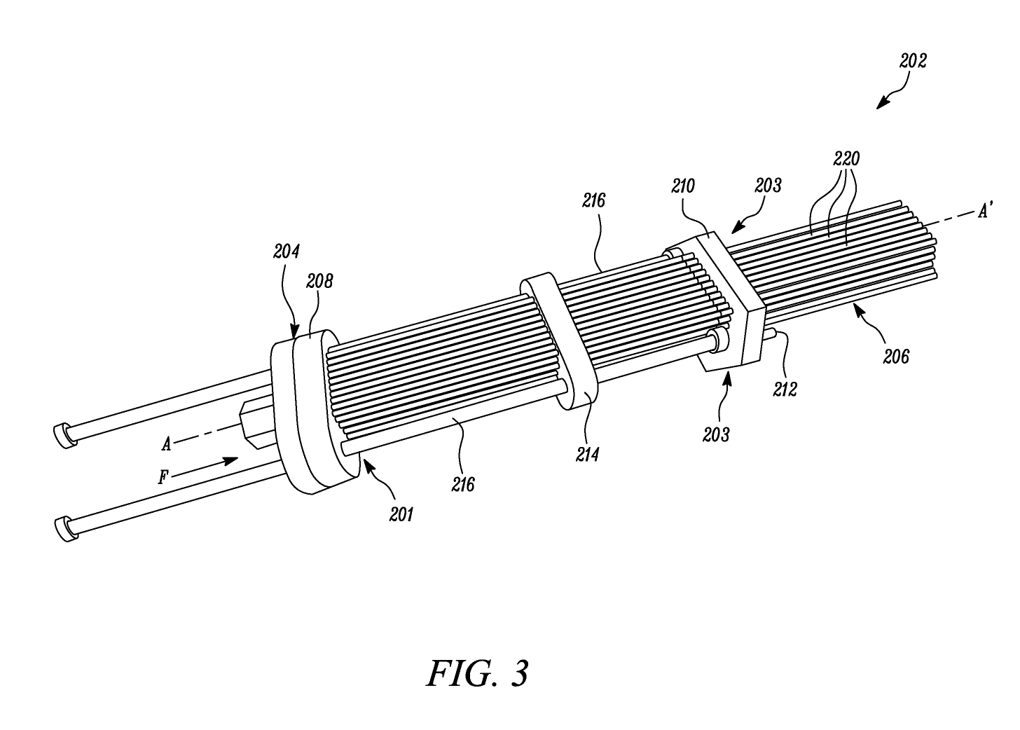

Referring to FIG. 3, during operation of the cleaning tool 202, an action of an external force “F” on the base block 208 causes the pins 220 of the cleaning tool 202 to slide through the openings provided through the support block 214 and the locator block 210. Hence, the pins 220 are pushed to extend beyond the locator block 210 of the cleaning tool 202. Further, a contemporaneous sliding motion of the support rods 216 takes place relative to the locator block 210 of the cleaning tool 202, causing the support rods 216 to slide through the corresponding openings provided through the support block 214 and the base block 208. The support rods 216 extend beyond the base block 208. The external force “F” may be applied by any known external device or by manual effort.

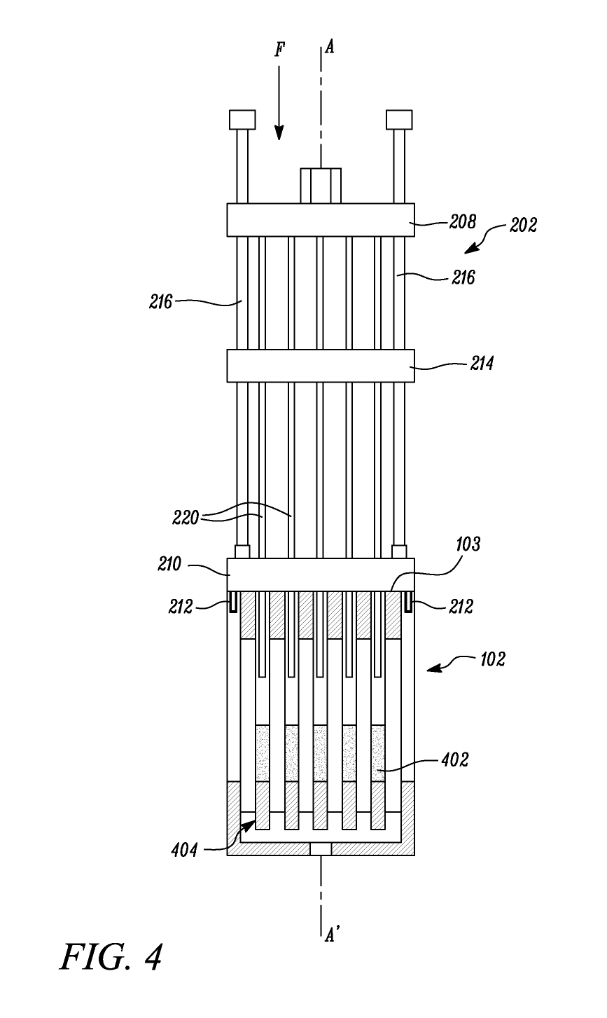

The procedure of operation of the cleaning tool 202 with respect to the diesel particulate filter 102 will now be described in detail. The dimensions of the cleaning tool 202, and specifically the gaps between the pins 220 of the cleaning tool 202 are exaggerated in the accompanying figures for illustration purposes. Referring to FIG. 4, during cleaning, the indexing pins 212 of the cleaning tool 202 are used to align and position the cleaning tool 202 on the inlet face 103 of the diesel particulate filter 102. The indexing pins 212 are secured onto the inlet face 103 of the diesel particulate filter 102 to hold the cleaning tool 202 in position. The external force “F” is applied on the base block 208, causing the pins 220 to enter into the passages 122 of the diesel particulate filter 102. As is visible, the pins 220 are arranged in such a manner, that the pins 220 may slide into alternate passages 122 of the diesel particulate filter 102.

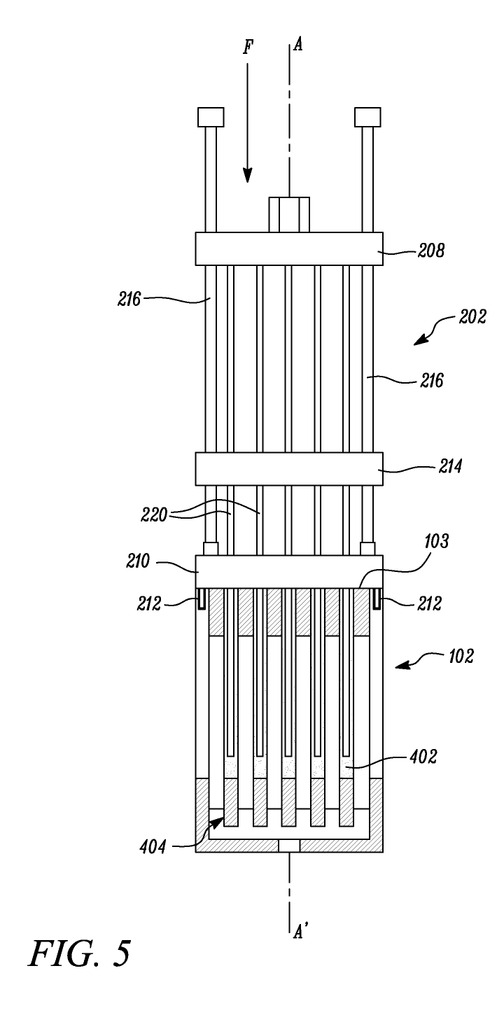

Further, as shown in FIG. 5, the pins 220 further move into the passages 122 and penetrate into the ash columns 402 deposited at one end 404 of the diesel particulate filter 102. The pins 220 dislodge and loosen the ash column 402 from the passage 122. As described earlier, the vacuum source 108 may then be connected to the end 404 of the diesel particulate filter 102 so that the loosened ash particles may be blown out of the diesel particulate filter 102. Based on the requirement, multiple passes of extension and retraction of the pins 220 of the cleaning tool 202 may be utilized to dislodge the ash columns 402 from the diesel particulate filter 102.

### INDUSTRIAL APPLICABILITY

The industrial applicability of the cleaning tool 202 described herein will be readily appreciated from the foregoing discussion. The cleaning tool 202 is provided with the locator block 210 and the indexing pins 212 that aids in proper alignment and positioning of the cleaning tool 202 on the diesel particulate filter 102. The pins 220 of the cleaning tool 202 are sized to be received into the passages 122 of the diesel particulate filter 102. The cleaning tool 202 described herein is a simple, cost effective tool, having a compact design which can be incorporated with any diesel particulate filter 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cleaning tool for a diesel particulate filter, the diesel particulate filter including a plurality of passages, the cleaning tool comprising:
a support assembly including:
a base block provided at one end of the cleaning tool;
a locator block provided at another end of the cleaning tool, the locator block including a plurality of indexing pins, wherein the plurality of indexing pins are configured to align and position the cleaning tool on an inlet face of the diesel particulate filter;
a support block provided between the base block and the locator block; and
a pair of support rods laterally spaced apart with respect to a central axis of the cleaning tool, each of the pair of support rods fixedly connected to the locator block and slidably connected to the base block and the support block, wherein an action of an external force on the base block causes a contemporaneous sliding motion of the pair of support rods; and
a cleaning assembly coupled to the support assembly, the cleaning assembly including:
a plurality of pins connected to and passing through the base block, the support block, and the locator block, the plurality of pins positioned between the pair of support rods, such that a diameter of each of the plurality of pins is smaller than a diameter of each of the plurality of passages of the diesel particulate filter, wherein each of the plurality of pins is configured to contemporaneously enter into each of the plurality of passages based on the action of the external force, such that the each of the plurality of pins is configured to penetrate an ash column deposited at one end of the respective passage and dislodge the ash column therefrom.
